(19) United States
(12) Patent Application Publication
(10) Pub. No.: US 2011/0014367 A1
(43) Pub. Date: Jan. 20, 2011

(54) Epoxy Applicator with Temperature Control

(76) Inventor: Dennis Ray Wells, Richfield, MN (US)

Correspondence Address: MERCHANT & GOULD PC, P.O. BOX 2903, MINNEAPOLIS, MN, 55402-0903, US

(21) Appl. No.: 12/836,844

(22) Filed: Jul. 15, 2010

Related U.S. Application Data
(60) Provisional application No. 61/226,454, filed on Jul. 17, 2009.

(51) Int. Cl. B05D 1/26; F25B 21/02; B67D 7/08; B67D 7/58

(52) U.S. Cl. 427/163.2; 62/3.2; 222/54; 222/386

(57) ABSTRACT

The present disclosure relates to an epoxy applicator including an epoxy dispenser and a thermal pump. The epoxy dispenser includes an epoxy holding cavity that is cooled by the thermal pump via a thermal conduction member. A control system can regulate a temperature of the epoxy applicator and thereby regulate a temperature of uncured epoxy in the epoxy holding cavity. The present disclosure also relates to a syringe chiller for chilling a syringe. The syringe chiller includes a thermal conduction block adapted to thermally couple to and hold an exterior of the syringe. The syringe chiller also includes a Peltier effect device with a hot side and a cold side. The cold side of the Peltier effect device is thermally coupled to the thermal conduction block. The syringe chiller can include a control system to regulate a temperature of the syringe.

### CROSS-REFERENCE TO RELATED APPLICATION

This application claims the benefit of U.S. Provisional Patent Application Ser. No. 61/226,454, filed Jul. 17, 2009, which application is hereby incorporated by reference in its entirety.

### TECHNICAL FIELD

The present disclosure relates to epoxy applicators and, more particularly, to epoxy applicators suitable for use in preparing fiber optic connectors.

### BACKGROUND

Epoxy adhesives have been used in bonding and securing electrical and optic components. Epoxies are typically a thermosetting polymer that cures when mixed with a catalyzing agent or hardener. Epoxies typically have a consistency ranging from liquid to putty prior to being cured. After curing, epoxies typically set up as a solid resistant to deformation. Cured epoxy properties such as heat and chemical resistance are suitable for many applications including consumer, marine, tooling, dentistry, aerospace, optic, and fiber optic applications.

### SUMMARY

Features of the present disclosure relate to an epoxy applicator. The epoxy applicator includes an epoxy dispenser (e.g., a syringe), a thermal conduction member (e.g., an aluminum block), and a thermal pump. The epoxy dispenser includes an epoxy holding cavity and an epoxy nozzle. The epoxy nozzle includes an epoxy flow passage that connects the epoxy holding cavity to an outlet of the epoxy nozzle. The thermal conduction member is thermally coupled to a wall of the epoxy holding cavity. The thermal pump includes a thermal energy source surface (i.e., a cold side) and a thermal energy sink surface (i.e., a hot side). The thermal energy source surface is thermally coupled to the thermal conduction member. The thermal energy sink surface is adapted to dissipate thermal energy into a surrounding environment. The thermal pump has an active state and an inactive state. When the thermal pump is in the active state, the thermal pump transfers the thermal energy from the thermal energy source surface to the thermal energy sink surface and thereby lowers a temperature of the thermal energy source surface. The lowered temperature of the thermal energy source surface of the thermal pump, in turn, lowers a temperature of the thermal conduction member, and the lowered temperature of the thermal conduction member, in turn, lowers a temperature of the wall of the epoxy holding cavity of the epoxy dispenser.

The epoxy applicator can also include one or more temperature sensors adapted for measuring the temperatures of the thermal energy source surface, the thermal conduction member, and/or the wall of the epoxy holding cavity. The epoxy applicator can also include a control unit that drives one or more of the temperatures or an average of the temperatures measured by the temperature sensors toward a temperature set point.

The thermal pump of the epoxy applicator can be or include a Peltier effect device, a vapor-compression refrigeration device, or other device capable of transferring the thermal energy (i.e., heat) away from the epoxy holding cavity.

The epoxy applicator can be adapted for injecting uncured epoxy, loaded in the epoxy holding cavity, into a hub and/or a ferrule of a fiber optic connector. For example, the epoxy nozzle of the epoxy applicator can be a hollow needle and the outlet can be positioned at a tip of the hollow needle. The hollow needle can include a tapered seat positioned around the outlet at the tip of the hollow needle. The tapered seat of the hollow needle can be adapted to seat against a chamfer of a ferrule of a fiber optic connector.

The epoxy applicator can include a fan, adapted to move air across the thermal energy sink surface of the thermal pump, and insulation around at least a portion of an exterior of the thermal conduction member. Insulation can also be applied on and around at least portions of the epoxy dispenser.

The epoxy dispenser can be removably mounted to other members of the epoxy applicator. For example, the thermal conduction member can include a through-hole adapted to hold and thermally couple with the epoxy dispenser. The epoxy dispenser can be inserted and removed from the through-hole.

Features of the present disclosure also relate to a syringe chiller for chilling a syringe. The syringe chiller includes a thermal conduction block and a Peltier effect device. The thermal conduction block includes an exterior surface and a through-hole adapted to thermally couple to and hold an exterior of the syringe. The Peltier effect device includes a hot side and a cold side. The cold side is thermally coupled to the exterior surface of the thermal conduction block, and the hot side is adapted to dissipate thermal energy into a surrounding environment. The Peltier effect device includes electrical power leads. A temperature of the hot side increases and a temperature of the cold side decreases when a voltage is applied across the electrical power leads. Applying the voltage thereby transfers the thermal energy from the cold side to the hot side of the Peltier effect device. The cold side of the Peltier effect device cools the exterior surface of the thermal conduction block and thereby cools the through-hole of the thermal conduction block when the voltage is applied across the electrical power leads of the Peltier effect device.

The syringe chiller can include a control system and one or more temperature sensors. The temperature sensors can measure either or both the temperature of the cold side of the Peltier effect device and/or a temperature of the thermal conduction block. The control system can drive the temperatures measured by the temperature sensors or their average toward a desired temperature by regulating the voltage applied across the electrical power leads of the Peltier effect device.

The syringe chiller can include a fan adapted to move air across the hot side of the Peltier effect device. The syringe chiller can include insulation around at least a portion of an exterior of the thermal conduction block.

These and other features and advantages will be apparent from a reading of the following detailed description and a review of the associated drawings. It is to be understood that both the forgoing general description and the following detailed description are explanatory only and are not restrictive of the broad aspects of the disclosure.

### BRIEF DESCRIPTION OF THE DRAWINGS

FIG. 1 is a perspective view showing an epoxy applicator in accordance with the principles of the present disclosure;

FIG. 2 is another perspective view showing the epoxy applicator of FIG. 1;

FIG. 3 is still another perspective view showing the epoxy applicator of FIG. 1 with a tip of the epoxy applicator near a ferrule assembly of a fiber optic connector;

FIG. 4 is an enlarged partial view of FIG. 3 showing the tip of FIG. 3 in greater detail;

FIG. 5 is the perspective view of FIG. 3 but with the tip and the ferrule assembly of FIG. 3 engaged with each other;

FIG. 6 is the perspective view of FIG. 5 but with a cross-sectional cut through the epoxy applicator and the ferrule assembly revealing their inner details;

FIG. 7 is an enlarged partial view of FIG. 6 showing the cross-sectioned tip and the cross-sectioned ferrule assembly of FIG. 3 in greater detail;

FIG. 8 is an exploded perspective view of the epoxy applicator of FIG. 1;

FIG. 9 is another exploded perspective view of the epoxy applicator of FIG. 1;

FIG. 10 is a schematic illustration of the epoxy applicator of FIG. 1 connected to a control system;

FIG. 11 is a perspective view showing a fiber optic cable terminated by a fiber optic connector; and

FIG. 12 is the perspective view of FIG. 11 but with a cross-sectional cut through the fiber optic cable and the fiber optic connector revealing their inner details and with a cap and a cap strap removed.

### DETAILED DESCRIPTION

The present disclosure describes example methods of chilling epoxy adhesive in an epoxy applicator. In addition, the present disclosure describes regulating a temperature of the epoxy applicator and a temperature of the epoxy adhesive within the epoxy applicator.

Epoxies are typically stored as two components for an extended period of time in a liquid, a gel, or a putty form. Before use, the two components of a typical epoxy are mixed together starting a curing process. A limited amount of time is available to apply the mixed epoxy before it cures to a solid form. The limited amount of time before curing depends, in part, on a temperature of the mixed epoxy. A cooler temperature of the mixed epoxy typically extends the curing time while a warmer temperature typically shortens the curing time.

The mixed epoxy can be loaded into an epoxy applicator to aid in the application of the mixed epoxy (e.g., in placing the mixed epoxy between two or more components to be bonded together). The two components of the epoxy can also be mixed by an epoxy applicator while the epoxy is being applied. By cooling the temperature of either the mixed epoxy or the two components of the epoxy before mixing, the curing time of the epoxy can be extended. By controlling the temperature of either the mixed epoxy or the two components of the epoxy before mixing, consistency of the curing time and consistency of the cured epoxy can be increased.

In applications, such as an assembly line, where doses of the mixed epoxy are applied to multiple units, extending the curing time of the mixed epoxy, loaded into the epoxy applicator, can increase the number of units that are processed before the mixed epoxy cures inside the epoxy applicator and becomes unusable. Therefore, extending the curing time of the mixed epoxy inside the epoxy applicator can spread the cost of the mixed epoxy over a greater number of units and reduce waste.

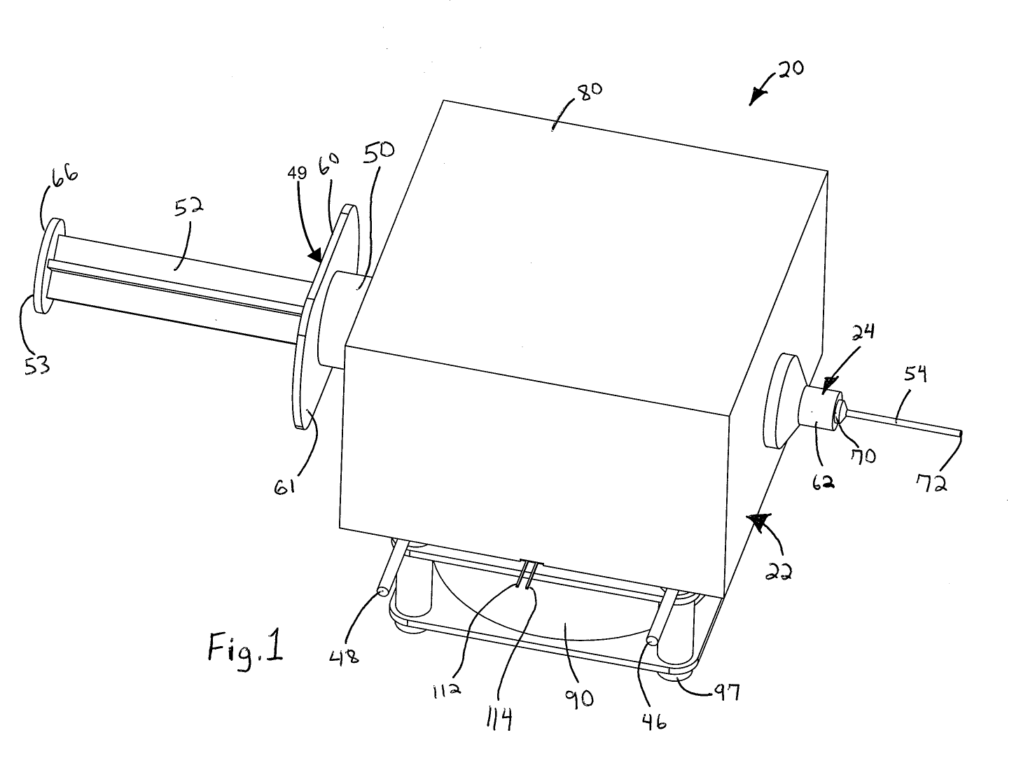

FIGS. 1 and 2 show an example epoxy applicator 20 in accordance with the principles of the present disclosure. The epoxy applicator 20 includes a thermal unit 22 and an epoxy dispenser 24.

The epoxy dispenser 24 can include a syringe 49 including a syringe body 50 and a plunger 52, as illustrated, or can be other means for storing and dispensing epoxy 10 (see FIG. 6). The syringe 49 can be disposable after use or reusable. The syringe 49 can include a single chamber in the syringe body 50 and a single piston on the plunger 52, as illustrated, or can include double chambers or multiple chambers in a syringe body and double pistons or multiple pistons on a plunger.

The syringe 49 is illustrated in cross-section at FIG. 6 and exploded at FIGS. 8 and 9. The syringe 49 includes a thermal contact surface 51 (shown on an exterior of the syringe body 50 at FIG. 9). The syringe body 50 extends from a first end 60 to a second end 62 and includes a bore 58 open to the first end 60. The first end 60 of the syringe body 50 can include a flange 61, and the second end 62 of the syringe body 50 can include a necked down region, open to the bore 58, surrounding an outlet of the syringe body 50. The plunger 52 of the syringe 49 extends from a first end 66 to a second end 68 and includes a sealing piston 64 at the second end 68. The first end 66 of the plunger 52 can include an actuation surface 53. A hollow needle 54 can be mounted in the outlet of the syringe body 50. The hollow needle 54 extends from a first end 70 to a second end 72 (i.e., a tip) and includes a passage 74 extending from the first end 70 to the second end 72. The first end 70 of the hollow needle 54 can be held within the second end 62 of the syringe body 50. The passage 74 of the hollow needle 54 is open to the bore 58 of the syringe body 50. The second end 72 (i.e., the tip) of the hollow needle 54 can include a tapered seat 76 surrounding the passage 74 at the second end 72.

When the second end 68 of the plunger 52 is inserted into the bore 58 of the syringe body 50 through the first end 60 (see FIG. 9), a cavity 56 is formed within the syringe 49 between the sealing piston 64 and an end wall at the second end 62 of the syringe body 50. The cavity 56 is further bounded by the bore 58 surrounded by a circumferential wall of the syringe body 50. The epoxy 10 can be loaded into the bore 58 through the first end 60 prior to inserting the plunger 52 into the bore 58, or the epoxy 10 can be drawn into the cavity 56. To draw the epoxy 10 into the cavity 56, the second end 68 of the plunger 52 can be fully inserted into the bore 58. The epoxy 10 can then be drawn into the cavity 56 by pulling the plunger 52 away from the second end 62 of the syringe body 50. To expel the epoxy 10 from the cavity 56, an operator's first and second fingers can be hooked under the flange 61 of the syringe body 50 while the operator's thumb presses against the actuation surface 53 of the plunger 52. This action creates pressure within the cavity 56 and urges the epoxy 10 out through the outlet of the syringe body 50. If the hollow needle 54 is attached to the syringe body 50, as described above and illustrated at FIG. 6, the epoxy 10 will be urged through the passage 74 of the hollow needle 54 and out of the second end 72 of the hollow needle 54.

The thermal unit 22 of the epoxy applicator 20 can include a Peltier device 40 as illustrated at FIGS. 2, 8, and 9. The thermal unit 22 can include a vapor-compression refrigeration device or other device capable of transferring thermal energy (i.e., a thermal pump). The Peltier device 40 creates a temperature gradient from an applied electrical voltage by employing the thermoelectric effect (i.e., the Seebeck effect, the Thomson effect, the Peltier-Seebeck effect, etc.). When the electrical voltage is applied across a first lead 46 and a second lead 48 of the Peltier device 40, a thermal energy source surface 42 (i.e., a cold side) and a thermal energy sink surface 44 (i.e., a hot side) is formed on the Peltier device 40. Thermal energy (i.e. heat) is drawn from the cold side 42 and transferred to the hot side 44 thereby cooling the cold side 42 and heating the hot side 44. In the figures, the cold side 42 and the hot side 44 of the Peltier device 40 are shown as planar and on opposing sides. Alternatively, the cold side 42 and the hot side 44 could be cylindrical. For example, the Peltier device 40 can take a form of a tube, and the cold side 42 can be a portion or all of an inside surface of the tube, and the hot side 44 can be a portion or all of an outside surface of the tube.

To cool the syringe 49, the cold side 42 of the Peltier device 40 is thermally connected to the thermal contact surface 51 of the syringe 49. As illustrated at FIGS. 2, 6, 8, and 9, a thermal conduction member 30 includes a syringe contacting surface 32 and a Peltier contacting surface 34. The thermal conduction member 30 is preferably made from a material with good thermal conduction properties (e.g., aluminum, copper, or silver). The syringe contacting surface 32 of the thermal conduction member 30 is brought into thermal contact with the thermal contact surface 51 of the syringe, and the Peltier contacting surface 34 of the thermal conduction member 30 is brought into thermal contact with the cold side 42 of the Peltier device 40. The syringe 49 is thereby thermally connected with the cold side 42 of the Peltier device 40. In the illustrated embodiment, the thermal conduction member 30 is a separate piece from the Peltier device 40. In other embodiments, the thermal conduction member 30 can be integrated with the Peltier device 40.

The thermal conduction member 30 can further include a temperature sensor mount 38 and a temperature sensor lead channel 39.

The syringe contacting surface 32 of the thermal conduction member 30 can take the form of a through-hole. The syringe 49 can be easily installed and removed from the through-hole. Having the syringe 49 easily removable from the thermal conduction member 30 also allows the syringe 49 to be easily removable from the other components of the epoxy applicator 20 (e.g., the thermal unit 22). Having the syringe 49 be easily removable provides the benefit of conveniently filling the syringe 49 with the epoxy 10 in the absence of the rest of the epoxy applicator 20. Having the syringe 49 be easily removable also provides the benefit of being able to quickly and conveniently switch the syringes 49 (e.g., when using multiple syringes 49 and/or when using disposable syringes 49).

Insulation 80 can be applied to other surfaces 36 of the thermal conduction member 30 that do not have a primary function as a thermal contact. The insulation 80 improves the efficiency of the thermal unit 22 by limiting unwanted environmental thermal transfer. The insulation 80 includes an insulated side 86 and an environment side 88. The insulated side 86 is primarily in contact with the other surfaces 36 of the thermal conduction member 30, and the environment side 88 is primarily exposed to a surrounding environment (e.g., ambient air). The insulation 80 can include a first hole 82 and a second hole 84 that generally align with the through-hole of the syringe contacting surface 32 of the thermal conduction member 30. The insulation 80 can include a lead access 89. Insulation can also be applied to other components of the epoxy applicator 20. For example, all or a portion of the hollow needle 54, the syringe body 50, and/or the plunger 52 can be thermally insulated.

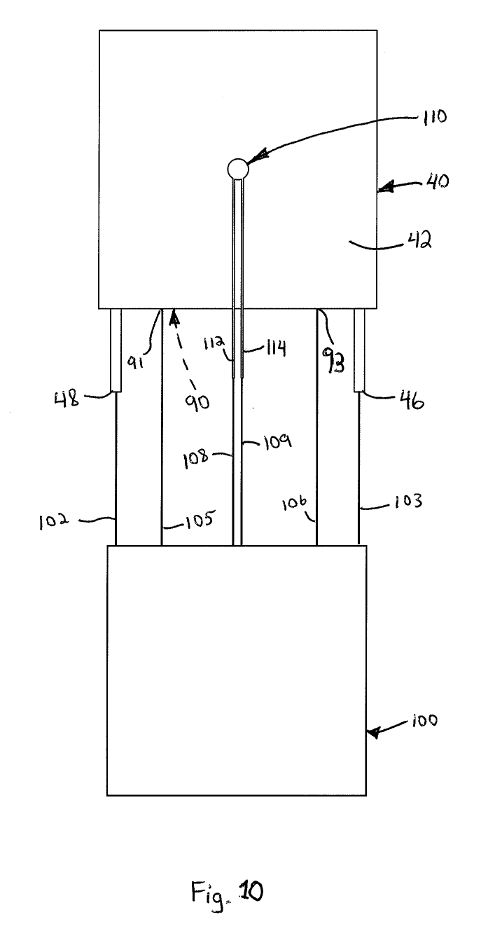

As illustrated at FIGS. 2, 8, and 9, the epoxy applicator 20 can include a fan 90. The fan 90 moves air across the hot side 44 of the Peltier device 40. By moving the air across the hot side 44, thermal energy (i.e., heat) can be removed from the hot side 44. As illustrated at FIG. 10, the fan 90 includes a first electrical power connection 91 and a second electrical power connection 93 to supply electrical power to an electric motor. When electrical power is supplied to the electric motor of the fan 90, the electric motor turns a fan blade of the fan 90, thereby moving the air into a first opening 92 and out of a second opening 94 of the fan 90. The rotational direction of the electric motor can be reversed thereby moving the air into the second opening 94 and out of the first opening 92 of the fan 90. The fan 90 can include a first set of mounts 96 and a second set of mounts 97. As illustrated at FIG. 2, the first set of mounts 96 can attach to the Peltier device 40. A gap 98 can be formed between the fan 90 and the hot side 44 of the Peltier device 40 by the first set of mounts 96. The gap 98 can allow air to pass through.

As illustrated at FIG. 10, the epoxy applicator 20 can include a controller 100 (i.e., a control system). The controller 100 can measure and regulate the temperature of the epoxy applicator 20 and therefore regulate the temperature of the epoxy 10 within the cavity 56. The controller 100 can further regulate a speed of the fan 90 and a rate of cooling. A temperature set point (i.e., a desired temperature) can be set on the controller 100 by an operator. The controller 100 can include a temperature indicator display, an on/off switch, fault indicators, etc. The controller 100 can include a power supply for the fan 90 and a power supply for the Peltier device 40. The controller can read a signal from a temperature sensor 110.

In the example illustrated at FIG. 10, a first Peltier power lead 102 of the controller 100 is connected to the second lead 48 of the Peltier 40, a second Peltier power lead 103 of the controller 100 is connected to the first lead 46 of the Peltier 40, a first fan power lead 105 of the controller 100 is connected to the first power connection 91 of the fan 90, a second fan power lead 106 of the controller 100 is connected to the second power connection 93 of the fan 90, a first temperature sensor signal lead 108 of the controller 100 is connected to a first lead 112 of the temperature sensor 110, and a second temperature sensor signal lead 109 of the controller 100 is connected to a second lead 114 of the temperature sensor 110.

The temperature sensor 110 can be mounted on or in the temperature sensor mount 38, as illustrated at FIGS. 8 and 9. The first and the second temperature sensor leads 112, 114 can be routed along the temperature sensor lead channel 39 and through the lead access 89 of the insulation 80.

The above components of the epoxy applicator 20 can be used to apply the epoxy 10 in various applications. A particular example application of applying the epoxy 10 to a fiber optic connector 201 and to a connector terminated fiber optic cable assembly 200 will be briefly described below. For further details on the fiber optic connector 201 and the connector terminated fiber optic cable assembly 200, see U.S. Provisional Patent Application Ser. No. 61/007,222, filed Dec. 11, 2007; U.S. Provisional Patent Application Ser. No. 61/029,524, filed Feb. 18, 2008; and the following U.S. Patent Applications, all filed on Sep. 3, 2008: U.S. patent application Ser. No. 12/203,508, entitled “Hardened Fiber Optic Connector Compatible with Hardened and Non-Hardened Fiber Optic Adapters”; U.S. patent application Ser. No. 12/203,522, entitled “Hardened Fiber Optic Connection System”; U.S. patent application Ser. No. 12/203,530, entitled “Hardened Fiber Optic Connection System with Multiple Configurations”; and U.S. patent application Ser. No. 12/203,535, entitled “Hardened Fiber Optic Connector and Cable Assembly with Multiple Configurations”; which applications are hereby incorporated by reference in their entirety.

The above components of the epoxy applicator 20 can also serve purposes other than applying epoxy. For example, the above components can serve as a syringe chiller. The syringe chiller can be used for a variety of purposes that syringes are used for.

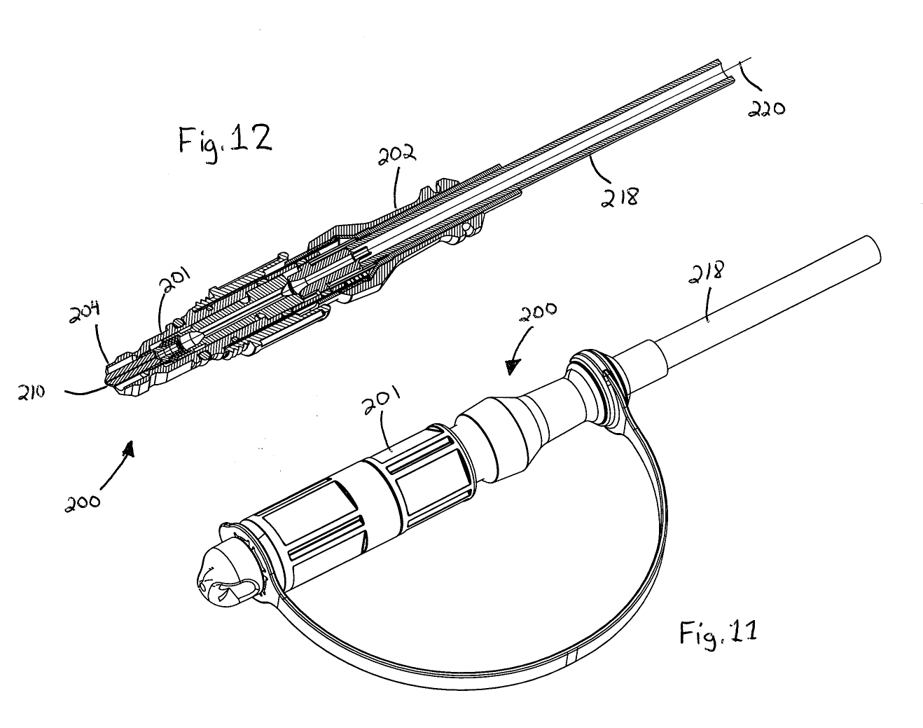

FIGS. 11 and 12 illustrated the fiber optic connector 201 and the connector terminated fiber optic cable assembly 200. The fiber optic connector 201 extends from a first end 202 to a second end 204. The first end 202 attaches to an end of a fiber optic cable 218 including an optical fiber 220. The second end 204 includes a ferrule assembly 210. The ferrule assembly 210 includes a ferrule 212 and a hub 214. A fiber bore 230 runs through the ferrule 212 and mounts (i.e., terminates) an end of the optical fiber 220. The hub 214 includes a fiber clearance bore 216 and a ferrule bore 215 (see FIG. 7). A first end 232 of the ferrule 212 is coincident with the end of the optical fiber 220. A second end 234 of the ferrule 212 is inserted into the ferrule bore 215 of the hub 214, and an outer surface 238 of the ferrule 212 is held in the ferrule bore 215. The ferrule 212 and the hub 214 can be pre-assembled.

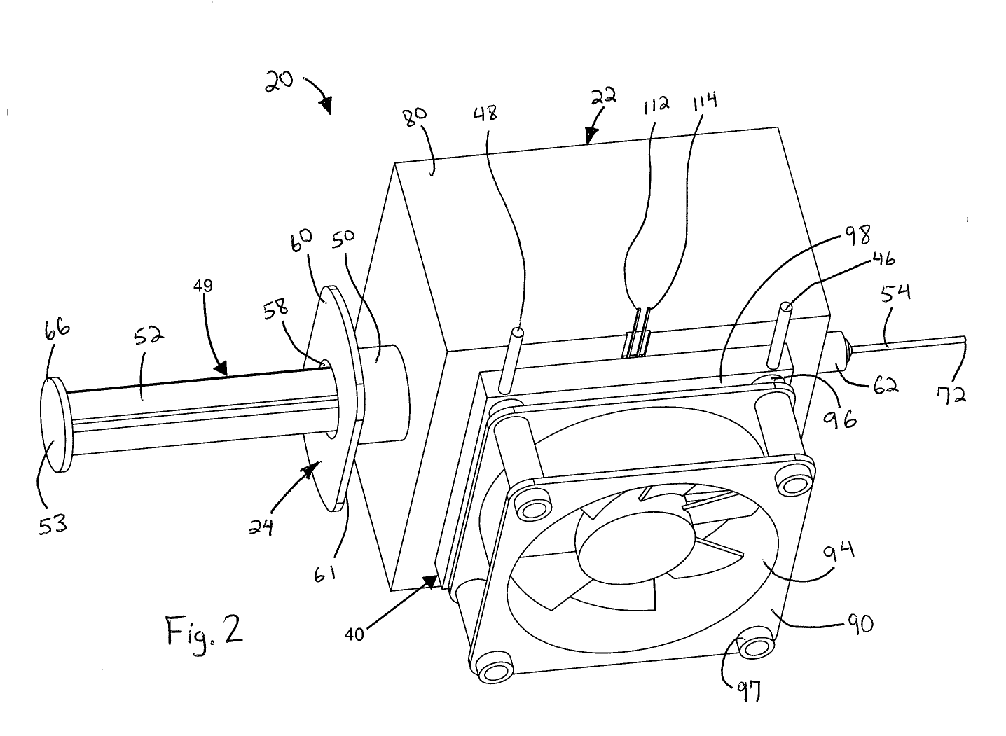

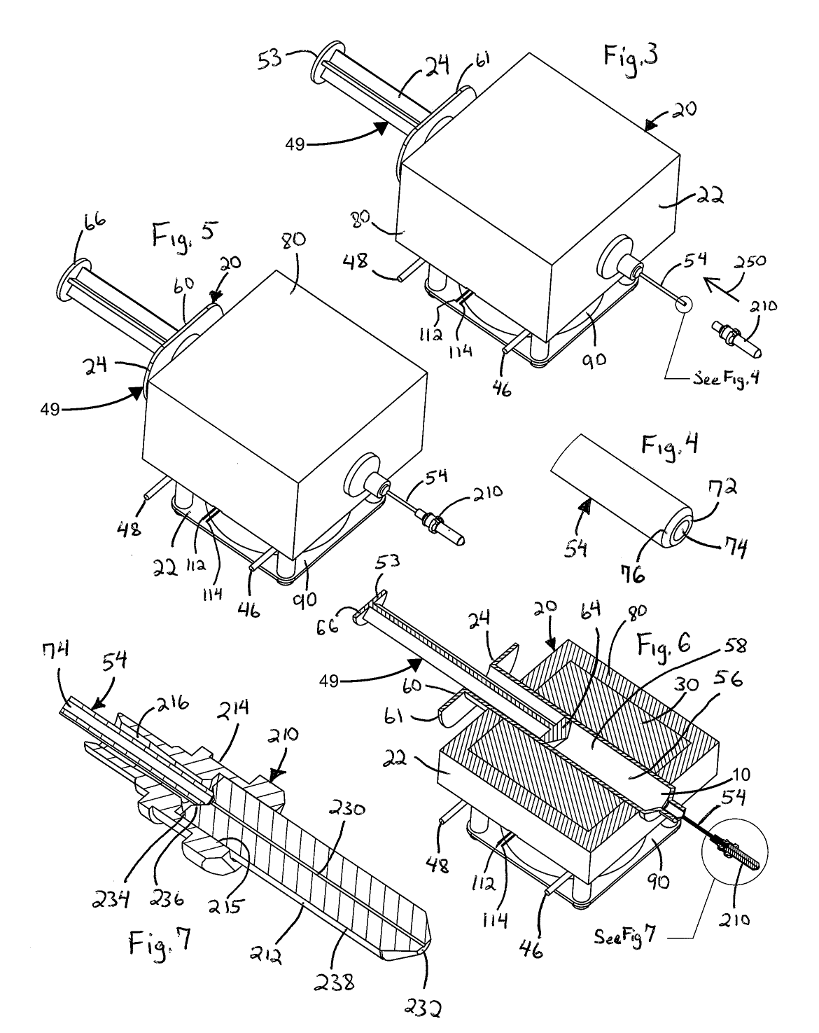

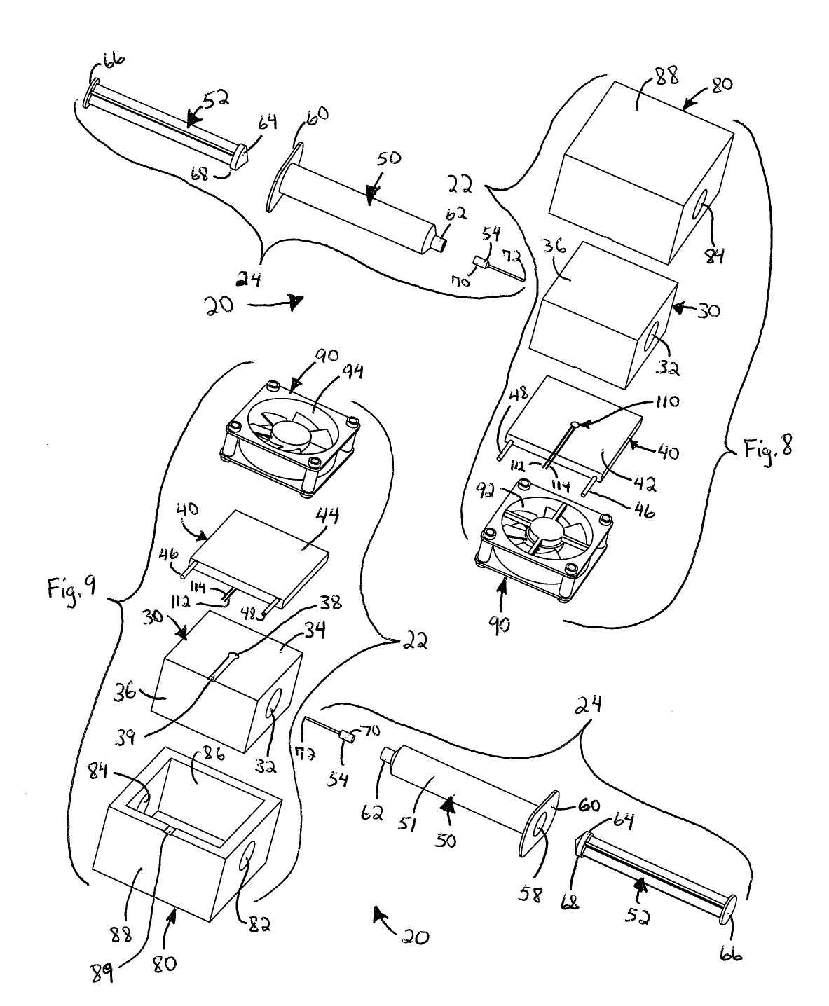

FIGS. 3-7 illustrate injecting the epoxy 10 into the fiber bore 230 of the ferrule 212. As illustrated, the ferrule assembly 210 is separated from the rest of the fiber optic connector 201. In other embodiments, the epoxy 10 can be injected into the fiber bore 230 while the ferrule assembly 210 is installed in the fiber optic connector 201 (a longer version of the hollow needle 54 can be used in this embodiment). The ferrule assembly 210 is positioned near the second end 72 of the hollow needle 54 as illustrated at FIG. 3. The ferrule assembly 210 is then moved in an insertion direction 250 causing the hollow needle 54 to pass through the fiber clearance bore 216 of the hub 214. The ferrule 212 is brought to rest against the second end 72 of the hollow needle 54 as shown at FIGS. 5-7. A taper seat 236 at the second end 235 of the ferrule 212 can be brought into contact with the tapered seat 76 of the hollow needle. A dose of the epoxy 10 is then injected into the fiber bore 230 of the ferrule 212. The ferrule assembly 210 can then be removed and installed in the fiber optic connector 201. The optical fiber 220 is inserted into the fiber bore 230 of the ferrule 212.

The epoxy adhesive 10 can be applied by the epoxy applicator 20 to other components of the fiber optic connector 201 and the fiber optic cable 218.

When the voltage polarity to the Peltier device 40 is reversed, the cold and the hot sides 42, 44 are switched. This effect can be used to warm the epoxy applicator 20 and warm the epoxy applicator 20 to a specified temperature. This effect can also be used to control the temperature of the epoxy applicator 20 by alternately adding and removing thermal energy as needed regardless if the ambient temperature is warmer or colder than the desired temperature.

Reversing the voltage polarity to the Peltier device 40, as described in the preceding paragraph, can also be applied to the syringe cooler, thereby transforming it into a syringe warmer. Likewise, the syringe cooler can be transformed into a syringe temperature maintaining device.

From the forgoing detailed description, it will be evident that modifications and variations can be made without departing from the spirit and scope of the disclosure.

What is claimed is:

1. An epoxy applicator comprising:
an epoxy dispenser including an epoxy holding cavity and an epoxy nozzle, the epoxy nozzle including an epoxy flow passage connecting the epoxy holding cavity to an outlet of the epoxy nozzle;
a thermal conduction member thermally coupled to a wall of the epoxy holding cavity; and
a thermal pump including a thermal energy source surface and a thermal energy sink surface, the thermal energy source surface thermally coupled to the thermal conduction member, the thermal energy sink surface adapted to dissipate thermal energy into a surrounding environment, and the thermal pump having an active state and an inactive state;
wherein the thermal pump transfers the thermal energy from the thermal energy source surface to the thermal energy sink surface thereby lowering a temperature of the thermal energy source surface when the thermal pump is in the active state;
wherein the lowered temperature of the thermal energy source surface of the thermal pump lowers a temperature of the thermal conduction member when the thermal pump is in the active state; and
wherein the lowered temperature of the thermal conduction member lowers a temperature of the wall of the epoxy holding cavity of the epoxy dispenser when the thermal pump is in the active state.

2. The epoxy applicator of claim 1, further comprising a temperature sensor adapted for measuring either the temperature of the thermal energy source surface, the temperature of the thermal conduction member, or the temperature of the wall of the epoxy holding cavity.

3. The epoxy applicator of claim 2, further comprising a control unit to drive the temperature measured by the temperature sensor toward a desired temperature.

4. The epoxy applicator of claim 1, wherein the thermal pump is a Peltier effect device.

5. The epoxy applicator of claim 1, wherein the epoxy nozzle is a hollow needle and the outlet is positioned at a tip of the hollow needle.

6. The epoxy applicator of claim 5, wherein the hollow needle includes a tapered seat positioned around the outlet at the tip of the hollow needle.

7. The epoxy applicator of claim 1, further comprising a fan adapted to move air across the thermal energy sink surface of the thermal pump.

8. An epoxy applicator comprising:
a syringe including a syringe body and a plunger, the syringe body extending from a first end to a second end and including a circumferential wall defining a bore accessible from the first end of the syringe body, the syringe body including an end wall with an outlet connected to the bore, the end wall positioned at the second end of the syringe body, the plunger extending from a first end to a second end, the second end of the plunger including a seal adapted to sealingly slide along the bore of the syringe body, the syringe including an epoxy cavity formed within the bore of the syringe body between the seal of the plunger and the end wall of the syringe body;
a thermal conduction block including an exterior surface and a through-hole adapted to thermally couple to and hold an exterior of the syringe body; and
a Peltier effect device including a hot side and a cold side, the cold side thermally coupled to the exterior surface of the thermal conduction block, the hot side adapted to dissipate thermal energy into a surrounding environment, the Peltier effect device including electrical power leads, a temperature of the hot side increasing and a temperature of the cold side decreasing when a voltage is applied across the electrical power leads thereby transferring the thermal energy from the cold side to the hot side of the Peltier effect device;
wherein the cold side of the Peltier effect device cools the exterior surface of the thermal conduction block and thereby cools the through-hole of the thermal conduction block when the voltage is applied across the electrical power leads of the Peltier effect device; and
wherein the cooled through-hole of the thermal conduction block cools at least a portion of the circumferential wall of the syringe body.

9. The epoxy applicator of claim 8, further comprising uncured epoxy within the epoxy cavity of the syringe, wherein the cooled portion of the circumferential wall of the syringe body cools the uncured epoxy.

10. The epoxy applicator of claim 8, further comprising a control system and a temperature sensor, the temperature sensor measuring either the temperature of the cold side of the Peltier effect device, a temperature of the thermal conduction block, or a temperature of the syringe, wherein the control system drives the temperature measured by the temperature sensor toward a desired temperature by regulating the voltage applied across the electrical power leads of the Peltier effect device.

11. The epoxy applicator of claim 9, further comprising a control system and a temperature sensor, the temperature sensor measuring either the temperature of the cold side of the Peltier effect device, a temperature of the thermal conduction block, a temperature of the syringe, or a temperature of the uncured epoxy, wherein the control system drives the temperature measured by the temperature sensor toward a desired temperature by regulating the voltage applied across the electrical power leads of the Peltier effect device.

12. The epoxy applicator of claim 10, further comprising a fan adapted to move air across the hot side of the Peltier effect device.

13. The epoxy applicator of claim 8, further comprising insulation around at least a portion of an exterior of the thermal conduction block.

14. The epoxy applicator of claim 8, further comprising a hollow needle extending between a first end and a second end and including a passage extending between the first and the second ends of the hollow needle, the first end of the hollow needle mounted to the outlet of the syringe body, the second end of the hollow needle including a tip adapted for injecting uncured epoxy into a ferrule of a fiber optic connector, and the passage of the hollow needle open to the epoxy cavity of the syringe.

15. The epoxy applicator of claim 9, further comprising a hollow needle extending between a first end and a second end and including a passage extending between the first and the second ends of the hollow needle, the first end of the hollow needle mounted to the outlet of the syringe body, the second end of the hollow needle including a tip adapted for injecting the uncured epoxy into a ferrule of a fiber optic connector, and the tip of the hollow needle including a tapered seat positioned around the passage of the hollow needle.

16. The epoxy applicator of claim 8, wherein the exterior of the syringe body of the syringe is removably mounted within the through-hole of the thermal conduction block, the second end of the plunger is removably mounted within the bore of the syringe body, and uncured epoxy can be loaded into the epoxy cavity of the syringe by removing the syringe from the thermal conduction block, removing the plunger from the bore of the syringe body, loading epoxy into the bore at the first end of the syringe body, reinstalling the plunger into the bore of the syringe body, and reinstalling the syringe into the thermal conduction block.

17. A method of applying uncured epoxy to a ferrule of a fiber optic connector, the method comprising:
loading the uncured epoxy into a syringe, the syringe including a hollow needle;
mounting the syringe into a syringe chiller;
engaging the hollow needle of the syringe and the ferrule; and
injecting the uncured epoxy into a fiber bore of the ferrule.

18. A method of applying uncured epoxy to a strength member receiver of a fiber optic connector and to a strength member of a fiber optic cable terminating within the strength member receiver of the fiber optic connector, the method comprising:
loading the uncured epoxy into a syringe, the syringe including an outlet;
mounting the syringe into a syringe chiller;
positioning the outlet of the syringe near the strength member receiver of the fiber optic connector; and
ejecting a portion of the uncured epoxy onto the strength member receiver of the fiber optic connector.

19. An epoxy applicator comprising:
a syringe including a syringe body and a plunger; and
a syringe chiller.

20. A syringe chiller for chilling a syringe, the syringe chiller comprising:
a thermal conduction block including an exterior surface and a through-hole adapted to thermally couple to and hold an exterior of the syringe; and
a Peltier effect device including a hot side and a cold side, the cold side thermally coupled to the exterior surface of the thermal conduction block, the hot side adapted to dissipate thermal energy into a surrounding environment, the Peltier effect device including electrical power leads, a temperature of the hot side increasing and a temperature of the cold side decreasing when a voltage is applied across the electrical power leads thereby transferring the thermal energy from the cold side to the hot side of the Peltier effect device;
wherein the cold side of the Peltier effect device cools the exterior surface of the thermal conduction block and thereby cools the through-hole of the thermal conduction block when the voltage is applied across the electrical power leads of the Peltier effect device.

21. The syringe chiller of claim 20, further comprising a control system and a temperature sensor, the temperature sensor measuring either the temperature of the cold side of the Peltier effect device or a temperature of the thermal conduction block, wherein the control system drives the temperature measured by the temperature sensor toward a desired temperature by regulating the voltage applied across the electrical power leads of the Peltier effect device.

22. The syringe chiller of claim 20, further comprising a fan adapted to move air across the hot side of the Peltier effect device.

23. The syringe chiller of claim 20, further comprising insulation around at least a portion of an exterior of the thermal conduction block.
